(19) United States
(12) Patent Application Publication
(10) Pub. No.: US 2024/0413904 A1
(43) Pub. Date: Dec. 12, 2024

(54) RECEPTION DEVICE AND COMMUNICATION DEVICE

(71) Applicant: NEC Corporation, Tokyo (JP)

(72) Inventors: Hisashi MIZUMOTO, Tokyo (JP); Fujio OKUMURA, Kanagawa (JP); Atsushi Kamoi, Tokyo (JP)

(73) Assignee: NEC Corporation, Tokyo (JP)

(21) Appl. No.: 18/645,610

(22) Filed: Apr. 25, 2024

(30) Foreign Application Priority Data
Jun. 8, 2023 (JP) 2023-094528

(51) Int. Cl. H04B 10/11; H04B 10/50; H04B 10/60

(52) U.S. Cl. CPC H04B 10/11; H04B 10/50; H04B 10/60

(57) ABSTRACT

A reception device including a ball lens, light receivers, and a support column that movably supports the light receiver around the ball lens. The light receiver includes a substrate having a first face facing a ball lens and a second face facing the first face, the substrate having a through hole that penetrates the first face and the second face, integration light receiving elements disposed around the through hole on the first face of the substrate with a light reception part facing the ball lens, a light guide tube including a first opening end aligned with the through hole and a second opening end facing the first opening end, the light guide tube being disposed at the second face associated with the through hole, and a communication light receiving element disposed at the second opening end of the light guide tube with a light reception part facing the ball lens.

This application is based upon and claims the benefit of priority from Japanese Patent Application No. 2023-094528, filed on Jun. 8, 2023, the disclosure of which is incorporated herein in its entirety by reference.

### TECHNICAL FIELD

The present disclosure relates to a reception device and a communication device.

### BACKGROUND ART

In spatial optical communication in a free space, signal light beams (hereinafter, also referred to as a spatial optical signal) propagating in the space are transmitted and received without using a medium such as an optical fiber. The spatial optical signal used in the optical spatial communication has higher directivity than the radio wave used in the wireless communication. The spatial optical signal does not interfere with the radio wave. In the field of spatial optical communication, an optical communication network can be constructed using optical communication devices facing each other. Since the spatial optical signal has high directivity, communication is interrupted when the spatial optical signal is physically blocked by the shielding object. Therefore, in spatial optical communication, an optical communication network made redundant by simultaneous multi-directional connection is required in order to achieve a stable optical communication environment.

PTL 1 (JP 2005-191696 A) discloses an optical wireless device that transmits and receives signal light between a master unit and a slave device (communication target). The master unit includes a plurality of transmission/reception elements and a designation means. The plurality of transmission/reception elements is disposed close to each other. The plurality of transmission/reception elements transmits and receives signal light to and from the slave device. The designation means designates an optimal transmission/reception element based on signal light from the slave device. In the method of PTL 1, an angle formed by an acceleration vector of a joint at the time of heel contact with respect to a motion trajectory (related to an angle of a knee) is calculated as a walking parameter using a triaxial acceleration sensor and a triaxial angular velocity sensor attached to a lower limb portion. However, in the method of PTL 1, it is not possible to generate information with which the behavior of the knee in the left-right direction can be grasped.

In the method of PTL 1, a transmission/reception element used for communication with a slave device is designated based on signal light received by a plurality of transmission/reception elements. According to the method of PTL 1, communication is established by transmission and reception of signal light to and from a communication target. However, in the method of PTL 1, depending on the incidence direction of the signal light on the light receiving face of the transmission/reception element, the signal light with sufficient intensity is not received by the transmission/reception element, and communication with the communication target cannot be established. That is, in the method of PTL 1, a communication angle of 360 degrees cannot be achieved.

An object of the present disclosure is to provide a reception device, a reception device, and a communication device capable of achieving a communication angle of 360 degrees.

### SUMMARY

A reception device according to an aspect of the present disclosure includes a ball lens, at least one light receiver, and a support column that movably supports the light receiver around the ball lens. The light receiver includes a substrate having a first face facing a ball lens and a second face facing the first face, the substrate having a through hole that penetrates the first face and the second face, a plurality of integration light receiving elements disposed around the through hole on the first face of the substrate with a light reception part facing the ball lens, a light guide tube including a first opening end aligned with the through hole and a second opening end facing the first opening end, the light guide tube being disposed at the second face associated with the through hole, and a communication light receiving element disposed at the second opening end of the light guide tube with a light reception part facing the ball lens.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a reception device according to the present disclosure;

FIG. 2 is a side view illustrating an example of a configuration of a light receiver included in the reception device of the present disclosure;

FIG. 3 is a perspective view illustrating an example of a configuration of a light receiver included in the reception device of the present disclosure;

FIG. 4 is a conceptual diagram for describing an example of a trace of signal light condensed by a ball lens included in the reception device in the present disclosure;

FIG. 5 is a conceptual diagram for describing an example of a state in which signal light condensed by a ball lens included in a reception device in the present disclosure is incident on a light receiver;

FIG. 6 is a conceptual diagram for describing another example of a state in which signal light condensed by a ball lens included in a reception device in the present disclosure is incident on the light receiver;

FIG. 7 is a conceptual diagram illustrating a reception example of the spatial optical signal for wide scan transmitted from the communication target of the reception device in the present disclosure;

FIG. 8 is a conceptual diagram illustrating an example of a condensing range of signal light condensed by the ball lens included in the reception device in the present disclosure;

FIG. 9 is a conceptual diagram illustrating a reception example of a spatial optical signal for narrow scan transmitted from a communication target of the reception device in the present disclosure;

FIG. 10 is a conceptual diagram illustrating an example of a condensing range of signal light condensed by the ball lens included in the reception device in the present disclosure;

FIG. 11 is a conceptual diagram of the light receiving face of the light receiver included in the reception device of the present disclosure when viewed from the parallax of the ball lens;

FIG. 12 is a conceptual diagram of the light receiving face of the light receiver included in the reception device of the present disclosure when viewed from the parallax of the ball lens;

FIG. 13 is a conceptual diagram illustrating an example in which the number of integration light receiving elements included in the light receiver included in the reception device of the present disclosure is increased;

FIG. 14 is a conceptual diagram illustrating an example in which the integration light receiving element included in the light receiver included in the reception device of the present disclosure is enlarged;

FIG. 15 is a perspective view illustrating an example of a light receiver included in the reception device of the present disclosure;

FIG. 16 is a side view illustrating an example of a light receiver included in the reception device of the present disclosure;

FIG. 17 is a perspective view illustrating an example of a light receiver included in the reception device of the present disclosure;

FIG. 18 is a block diagram illustrating an example of a configuration of a communication device according to the present disclosure;

FIG. 19 is a perspective view of an internal configuration of a transmission device included in the communication device of the present disclosure;

FIG. 20 is a side view of the internal configuration of the transmission device included in the communication device of the present disclosure;

FIG. 21 is a conceptual diagram for describing a transmission pattern of the search spatial optical signal transmitted from the transmission device included in the communication device in the present disclosure;

FIG. 22 is a block diagram illustrating an example of a configuration of a controller included in a reception device included in a communication device according to the present disclosure;

FIG. 23 is a conceptual diagram illustrating an example in which the position of the light receiver is changed according to the intensity of the signal light received by the plurality of integration light receiving elements included in the reception device included in the communication device of the present disclosure;

FIG. 24 is a conceptual diagram illustrating an example of changing the transmission direction of the spatial optical signal transmitted from the transmission device included in the communication device in the present disclosure;

FIG. 25 is a conceptual diagram for describing an example of transmission of a scanning spatial optical signal by a transmission device included in a communication device in the present disclosure;

FIG. 26 is a diagram for describing an example of a transmission pattern of a spatial optical signal transmitted from a transmission device included in a communication device in the present disclosure;

FIG. 27 is a conceptual diagram for describing an example of communication establishment between communication devices in the present disclosure;

FIG. 28 is a conceptual diagram for describing processing of optimizing a transmission direction of a spatial optical signal transmitted from a transmission device included in a communication device in the present disclosure;

FIG. 29 is a conceptual diagram for describing an example of identifying a position of a communication target using communication light transmitted from a transmission device included in a communication device in the present disclosure;

FIG. 30 is a flowchart for describing an example of control of the reception device by the communication control device included in the communication device in the present disclosure;

FIG. 31 is a flowchart for describing an example of control of the transmission device by the communication control device included in the communication device in the present disclosure;

FIG. 32 is a conceptual diagram illustrating an example of a configuration of a reception device in the present disclosure;

FIG. 33 is a side view illustrating an example of a configuration of a light receiver included in the reception device of the present disclosure;

FIG. 34 is a perspective view illustrating an example of a configuration of a light receiver included in the reception device of the present disclosure; and

FIG. 35 is a block diagram illustrating an example of a hardware configuration that executes control and processing in the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. A line indicating a trace of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a reception device according to a first example embodiment will be described with reference to the drawings. The communication device of the present example embodiment is used for optical spatial communication in which signal light (hereinafter, also referred to as a spatial optical signal) propagating in space is transmitted and received. The communication device of the present example embodiment may be used for applications other than optical spatial communication as long as the communication device is used for transmitting and receiving light propagating in a space. The drawings used in the description of the present example embodiment are conceptual and do not accurately depict an actual structure.

### (Configuration)

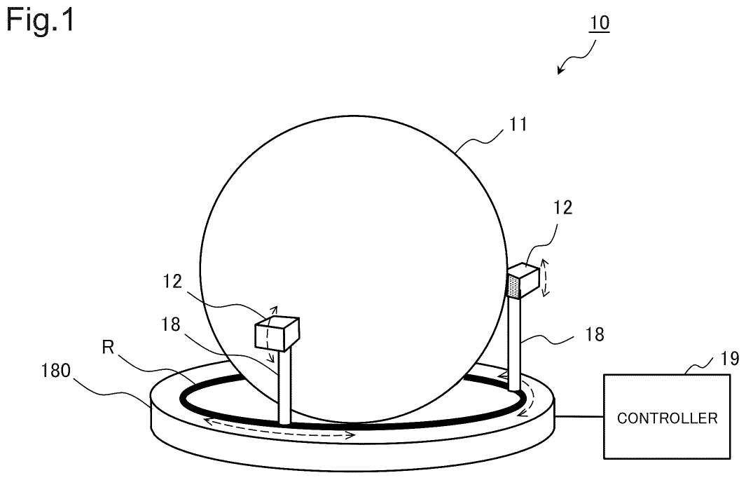

FIG. 1 is a conceptual diagram illustrating an example of a configuration of a reception device according to the present disclosure. FIG. 1 is a conceptual diagram of the reception device viewed from obliquely above. The reception device 10 includes a ball lens 11, a light receiver 12, a support column 18, a controller 19, and a base 180. The reception device 10 includes a driver (not illustrated) that changes the angle of the light receiving face of the light receiver 12 and the position of the support column 18. For example, the driver is achieved by a small motor such as a micro stepping motor.

A circular orbit R is disposed on the upper face of the base 180. The lower end of the support column 18 is movably disposed on the circular orbit R. The position of the light receiver 12 in the horizontal plane can be adjusted by moving the support column 18 along the circular orbit R. The support column 18 along circular orbit R is adjusted by driving control of a driver (not illustrated) by controller 19.

The light receiver 12 is disposed at the upper end of the support column 18. The light receiving face of the light receiver 12 faces the ball lens 11. For example, the reception device 10 is configured in such a way that the position of the light receiver 12 in the vertical direction can be changed along the circumference of the ball lens 11. For example, the light receiving face of the light receiver 12 is preferably disposed in such a way as to be changeable along the circumference of the ball lens 11. For example, the reception device 10 may be configured in such a way that the position of the light receiver 12 in the vertical direction is changed by expanding and contracting the support column 18.

The ball lens 11 is a spherical lens. The ball lens 11 is an optical element that collects a spatial optical signal (communication light, notification light) coming from the outside. The ball lens 11 has a spherical shape when viewed from an any angle. The ball lens 11 collects the incident spatial optical signal. Light (also referred to as a signal light) derived from the spatial optical signal condensed by the ball lens 11 is condensed toward the condensing region of the ball lens 11. Since the ball lens 11 has a spherical shape, the ball lens collects a spatial optical signal coming from an any direction. That is, the ball lens 11 exhibits similar light condensing performance for a spatial optical signal coming from an any direction. The light incident on the ball lens 11 is refracted when entering the ball lens 11. The light traveling inside the ball lens 11 is refracted again when being emitted to the outside of the ball lens 11. Most of the light emitted from the ball lens 11 is collected toward the condensing region.

For example, the ball lens 11 can be made of a material such as glass, crystal, or resin. In the case of receiving a spatial optical signal in the visible region, a material such as glass, crystal, or resin that transmits/refracts light in the visible region can be applied to the ball lens 11. For example, optical glass such as crown glass or flint glass can be applied to the ball lens 11. For example, crown glass such as Boron Kron (BK) can be applied to the ball lens 11. For example, flint glass such as Lanthanum Schwerflint (LaSF) can be applied to the ball lens 11. For example, quartz glass can be applied to the ball lens 11. For example, a crystal such as sapphire can be applied to the ball lens 11. For example, transparent resin such as acryl can be applied to the ball lens 11.

In a case where the spatial optical signal is light in a near-infrared region (hereinafter, also referred to as near infrared rays), a material that transmits near-infrared rays is used for the ball lens 11. For example, in a case of receiving a spatial optical signal in a near-infrared region of about 1.5 micrometers (μm), a material such as silicon can be applied to the ball lens 11 in addition to glass, crystal, resin, and the like. In a case where the spatial optical signal is light in an infrared region (hereinafter, also referred to as infrared rays), a material that transmits infrared rays is used for the ball lens 11. For example, in a case where the spatial optical signal is an infrared ray, silicon, germanium, or a chalcogenide material can be applied to the ball lens 11. The material of the ball lens 11 is not limited as long as light in the wavelength region of the spatial optical signal can be transmitted/refracted. The material of the ball lens 11 may be appropriately selected according to the required refractive index and use.

The light receiver 12 is disposed in a condensing region including a condensing point of the ball lens 11 in a state of being supported by the support column 18. The condensing point of the ball lens 11 is not uniquely determined. Therefore, the light receiver 12 is disposed in the condensing region including the condensing point of the ball lens 11. In the example of FIG. 1, the light receiver 12 is disposed on the side of the ball lens 11. The light receiving face of the light receiver 12 is disposed toward the center of the ball lens 11.

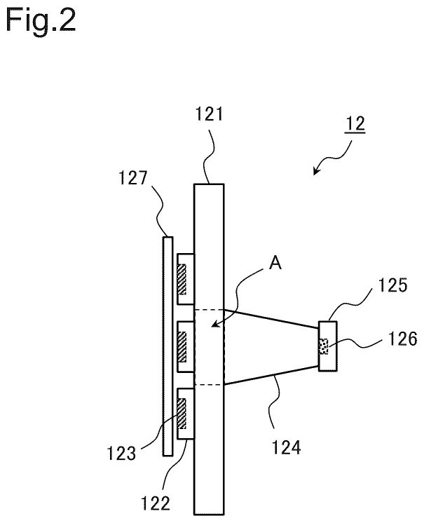

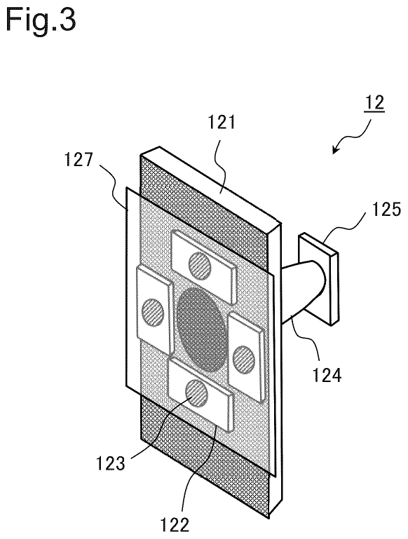

FIGS. 2 and 3 is a conceptual diagram illustrating an example of a configuration of the light receiver 12. FIG. 2 is a side view of the light receiver 12 when viewed from a side. FIG. 3 is a perspective view of the light receiving face of the light receiver 12 when viewed obliquely from above. The light receiver 12 includes a substrate 121, an integration light receiving element 122, a light guide tube 124, a communication light receiving element 125, and a filter 127. The light receiver 12 includes a plurality of integration light receiving elements 122. In the example of FIGS. 2 to 3, the light receiver 12 includes four integration light receiving elements 122. The number of the integration light receiving elements 122 is not limited to four.

The substrate 121 is a substrate used for a printed circuit board. A through hole A is formed in the substrate 121. The opening diameter of the through hole A is sized to fit the first opening end (the opening end on the left side in FIG. 2) of the light guide tube 124. On the first face (the face on the left side in FIG. 2) of the substrate 121, a plurality of integration light receiving elements 122 is disposed around the through hole A. In the example of FIGS. 2 to 3, four integration light receiving elements 122 are disposed around the through hole A.

The plurality of integration light receiving elements 122 is disposed on the first face (the face on the left side in FIG. 2) of the substrate 121. The plurality of integration light receiving elements 122 is disposed in a point-symmetric positional relationship with respect to the center of the through hole A of the substrate 121. A light reception part 123 of the integration light receiving element 122 is directed to the ball lens 11 via the filter 127. The integration light receiving element 122 has sensitivity to light in the wavelength band of the spatial optical signal to be communicated. For example, the integration light receiving element 122 is achieved by a photodiode having sensitivity to infrared rays. For example, the integration light receiving element 122 is achieved by an indium gallium arsenide InGaAs-based photodiode. For example, the communication light receiving element 125 is achieved by an InGaAs-based photodiode. Since the integration light receiving element 122 is only required to be able to detect the spatial optical signal, the sensitivity may be smaller than that of the communication light receiving element 125. Therefore, the integration light receiving element 122 may be achieved by a germanium Ge-based or silicon Si-based photodiode. The spatial optical signal received by the integration light receiving element 122 is converted into an electric signal. The converted electric signal is output to the controller 19. The converted electric signal is supplied to an integrator (not illustrated) included in the controller 19. The electric signal supplied to the integrator is integrated to a level at which the controller 19 can detect the signal.

The communication light receiving element 125 is disposed at the second opening end (the opening end on the right side in FIG. 2) of the light guide tube 124. A light reception part 126 of the communication light receiving element 125 is directed to the ball lens 11 via the filter 127. The communication light receiving element 125 has sensitivity to light in a wavelength band of a spatial optical signal to be communicated. For example, the communication light receiving element 125 is achieved by a photodiode having sensitivity to infrared rays. For example, in the communication light receiving element 125, a spatial optical signal received by the communication light receiving element 125 achieved by an indium gallium arsenide InGaAs-based photodiode is converted into an electric signal. The converted electric signal is output to the controller 19.

The filter 127 is a wavelength filter through which light in a wavelength band of a spatial optical signal to be received passes. The filter 127 transmits light in a wavelength band of a spatial optical signal to be received by the integration light receiving element 122 or the communication light receiving element 125 disposed at a subsequent stage. The filter 127 blocks light that is not a reception target. The main purpose of the filter 127 is to mitigate the effects of sunlight. In an environment less affected by sunlight or external light, the filter 127 may be omitted.

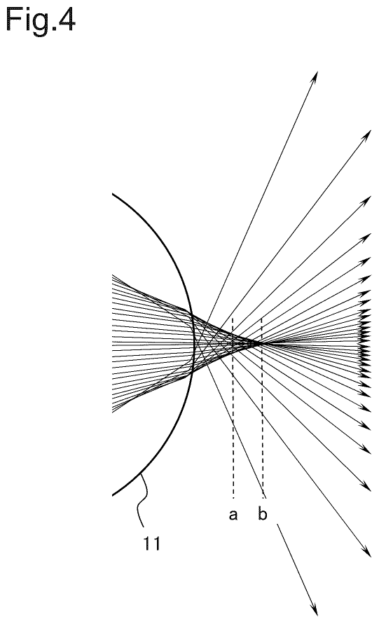

FIG. 4 is a conceptual diagram for describing an example of a trace of light condensed by the ball lens 11. FIG. 4 is a conceptual diagram of part of the ball lens 11 when viewed from a side. The intensity of light in the condensing region of the ball lens 11 changes according to the position from the ball lens 11. The flux density is large at a position b (also referred to as a condensing point), compared with a position a. Therefore, the intensity of the received light is larger at the position b. The light reception part 126 of the communication light receiving element 125 is disposed in the vicinity of the position b. Therefore, the light receiving efficiency of the signal light by the communication light receiving element 125 is improved. In other words, the light reception part 126 of the communication light receiving element 125 is disposed to coincide with the position b. On the other hand, the integration light receiving element 122 is disposed at a position closer to the ball lens 11 than the communication light receiving element 125.

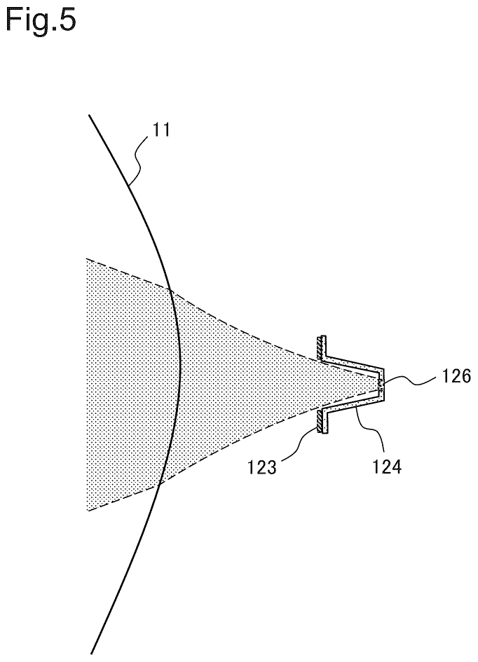

FIG. 5 is a conceptual diagram illustrating an example of a state in which the signal light condensed by the ball lens 11 is incident on the light receiver 12. FIG. 5 is a cross-sectional view of the light receiver 12 when viewed from a side. In the example of FIG. 5, the signal light condensed by the ball lens 11 is radiated to the light reception part 126 of the communication light receiving element 125. In the example of FIG. 5, the electric signal based on the signal light received by the communication light receiving element 125 is processed by the controller 19.

The controller 19 receives electric signals based on signal light received by the plurality of integration light receiving elements 122 and the communication light receiving element 125. The controller 19 decodes the received electric signal. For example, the controller 19 is achieved by a microcomputer including a processor and a memory. The controller 19 drives a first driver (not illustrated) that changes the angle of the light receiving face of the light receiver 12 and a second driver (not illustrated) that changes the position of the support column 18 according to the received electric signal to adjust the angle of the light receiving face of the light receiver 12 and the position of the support column 18. For example, each of the first driver and the second driver is achieved by a small motor such as a micro stepping motor.

The controller 19 adjusts the angle of the light receiving face of the light receiver 12 and the position of the support column 18 according to the intensity of the signal light received by each of the plurality of integration light receiving elements 122. The controller 19 aligns the position of the light reception part 126 of the communication light receiving element 125 with the position of the condensing point of the signal light condensed by the ball lens 11. For this purpose, the controller 19 moves the angle of the light receiving face of the light receiver 12 and the position of the support column 18 toward a direction of the integration light receiving element 122 whose reception intensity is high according to the intensity of the signal light received by each of the plurality of integration light receiving elements 122.

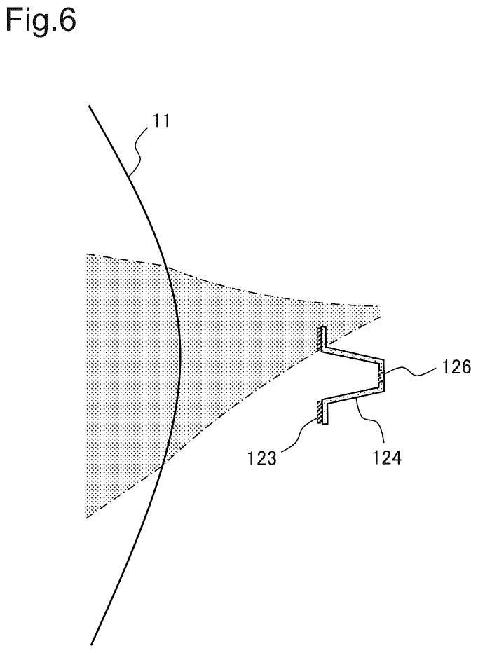

FIG. 6 is a conceptual diagram illustrating another example of a state in which the signal light condensed by the ball lens 11 is incident on the light receiver 12. FIG. 6 is a cross-sectional view of the light receiver 12 when viewed from a side. In the example of FIG. 6, the signal light condensed by the ball lens 11 is not radiated to the light reception part 126 of the communication light receiving element 125, but is radiated to the light reception part 123 of the integration light receiving element 122. In the example of FIG. 6, it is necessary to change the position of the light receiver 12. The controller 19 changes the position of the light receiver 12 according to the position of the integration light receiving elements 122 that has received the signal light. In the example of FIG. 6, the controller 19 moves the light receiver 12 upward.

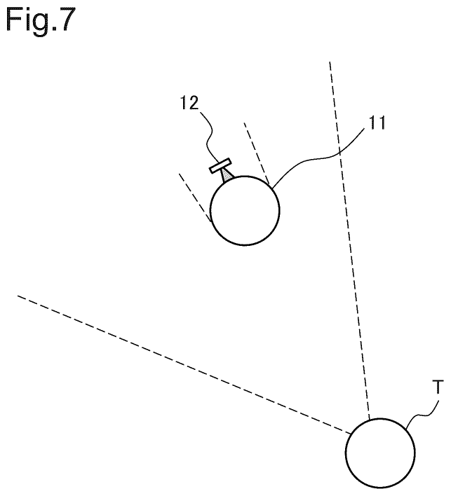

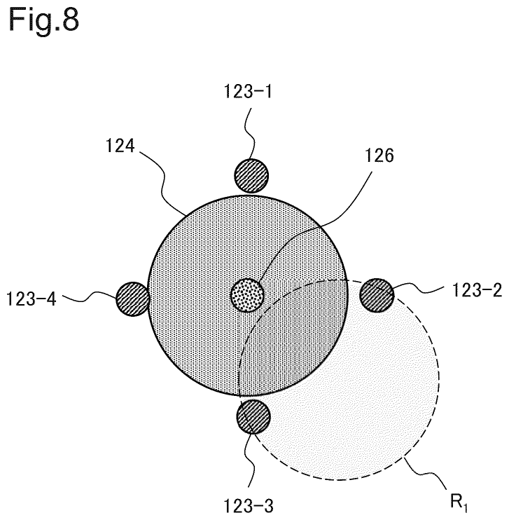

FIG. 7 is a conceptual diagram illustrating a reception example of the spatial optical signal for wide scan transmitted from a communication target T. FIG. 7 illustrates an example in which the spatial optical signal for wide scan is transmitted from the communication target T. FIG. 8 illustrates the light condensing range R₁ of the signal light condensed by the ball lens 11 in the example of FIG. 7. In FIG. 8, a number (1 to 4) is added to the end of the reference numeral representing the light reception part 123 of each of the plurality of integration light receiving elements 122 to distinguish them from each other. In the example of FIG. 8, the light reception part 123-2 and the light reception part 123-3 are included in the light condensing range R₁.

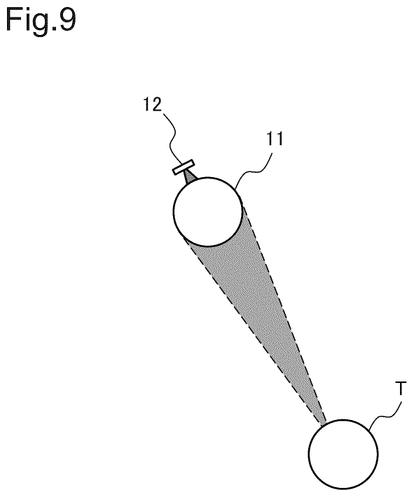

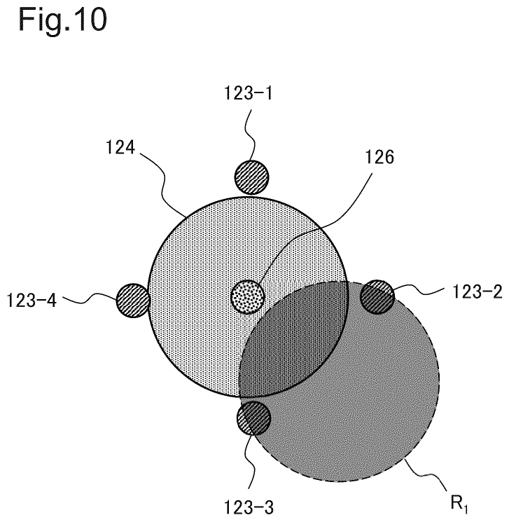

FIG. 9 is a conceptual diagram illustrating a reception example of the spatial optical signal for narrow scan transmitted from the communication target T. FIG. 9 illustrates an example in which a spatial optical signal for narrow scan is transmitted from the communication target T. FIG. 10 illustrates the light condensing range R₁ of the signal light condensed by the ball lens 11 in the example of FIG. 9. In FIG. 10, a number (1 to 4) is added to the end of the reference numeral representing the light reception part 123 of each of the plurality of integration light receiving elements 122 to distinguish them from each other. As in the example of FIG. 8, in the example of FIG. 10, the light reception part 123-2 and the light reception part 123-3 are included in the light condensing range R₁. In this way, when the positional relationship between the two devices is determined, the position of the condensing range of the signal light is uniquely determined. Since the search range of the spatial optical signal is narrowed in the narrow scan as compared with the wide scan, the intensity of the signal light condensed by the ball lens 11 is strong in the narrow scan.

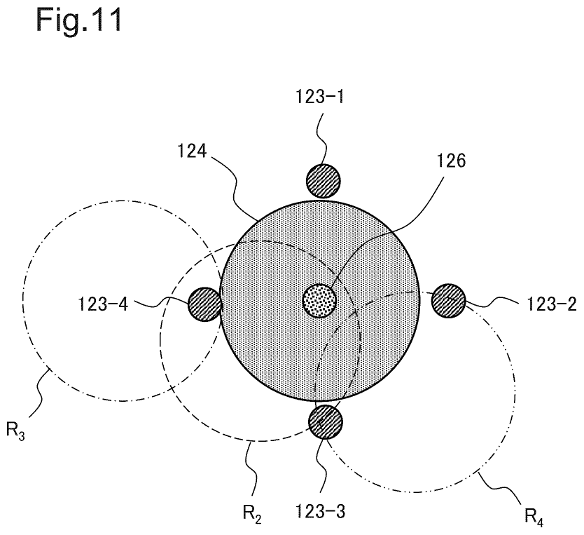

FIG. 11 is a conceptual diagram of the light receiving face of the light receiver 12 when viewed from the viewpoint of the ball lens 11. FIG. 11 illustrates a positional relationship between the light reception part 123 of the integration light receiving element 122 and the light reception part 126 of the communication light receiving element 125. In FIG. 11, a number (1 to 4) is added to the end of the reference numeral representing the light reception part 123 of each of the plurality of integration light receiving elements 122 to distinguish them from each other. FIG. 11 illustrates the inside of the light guide tube 124. The plurality of light reception parts 123-1 to 4 is disposed on a circumference centered on the light reception part 126 of the communication light receiving element 125. In FIG. 11, an example of a condensing range of light condensed by the ball lens 11 is indicated by a circle.

The signal light with which the light condensing range R₂ (broken line) is irradiated is received by the light reception part 126 of the communication light receiving element 125, and the light reception part 123-3 and the light reception part 123-4. According to the intensity of the signal light received by the light reception part 126, the light reception part 123-3, and the light reception part 123-4, the controller 19 moves the position of the light receiver 12 to the lower left.

The signal light with which the light condensing range R₃ (one-dot chain line) is irradiated is received by the light reception part 123-4. According to the intensity of the signal light received by the light reception part 123-4, the controller 19 moves the position of the light receiver 12 leftward.

The signal light with which the light condensing range R₄ (two-dot chain line) is irradiated is received by the light reception part 123-2 and the light reception part 123-3. According to the intensity of the signal light received by the light reception part 123-2 and the light reception part 123-3, the controller 19 moves the position of the light receiver 12 to the lower right.

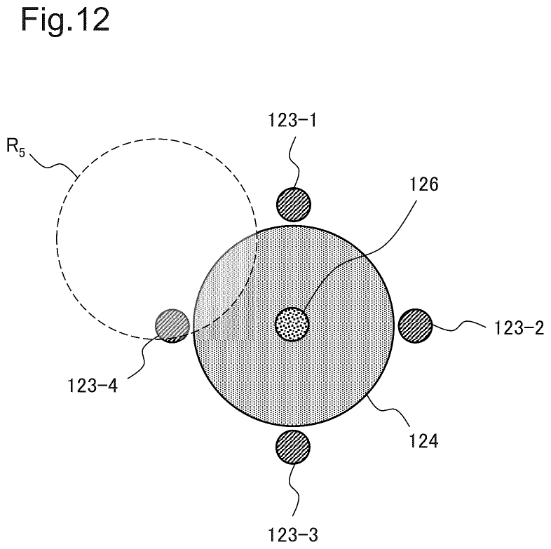

FIGS. 12 to 14 are conceptual diagrams illustrating an example of a light receiving state of signal light according to the number and size of the integration light receiving elements 122. FIGS. 12 to 14 are views when viewed from the ball lens 11. In the examples of FIGS. 12 to 14, the signal light condensed by the ball lens 11 is radiated to the light condensing range R₅.

FIG. 12 illustrates a configuration of the light receiver 12 described above. FIG. 12 illustrates the light reception part 123 of the integration light receiving element 122, the light reception part 126 of the communication light receiving element 125, and the inside of the light guide tube 124. In the example of FIG. 12, there are four light reception parts 123. In FIG. 12, a number (1 to 4) is added to the end of the reference numeral representing the light reception part 123 of each of the plurality of integration light receiving elements 122 to distinguish them from each other. In the example of FIG. 12, the signal light with which the light condensing range R₅ is irradiated is received by one light reception part 123-4 disposed on the left side.

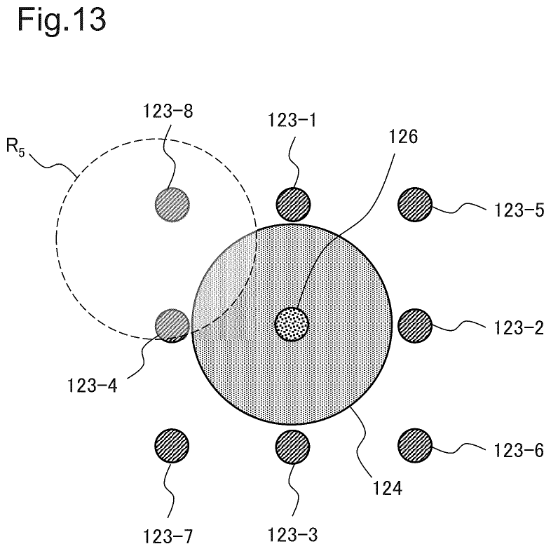

FIG. 13 illustrates an example in which the number of the integration light receiving elements 122 is increased. FIG. 13 illustrates the light reception parts 123-1 to 8 of the integration light receiving element 122, the light reception part 126 of the communication light receiving element 125, and the inside of the light guide tube 124. In the example of FIG. 13, there are eight integration light receiving elements 122. In FIG. 13, a number (1 to 8) is added to the end of the reference numeral representing each of the plurality of light reception parts 123 to distinguish them from each other. In the example of FIG. 13, the signal light with which the light condensing range R₅ is irradiated is received by the light reception part 123-4 and the light reception part 123-8. In the case of the configuration of FIG. 13, the signal light with which the light condensing range R₅ same as that in FIG. 12 is irradiated can be received by the two integration light receiving elements 122.

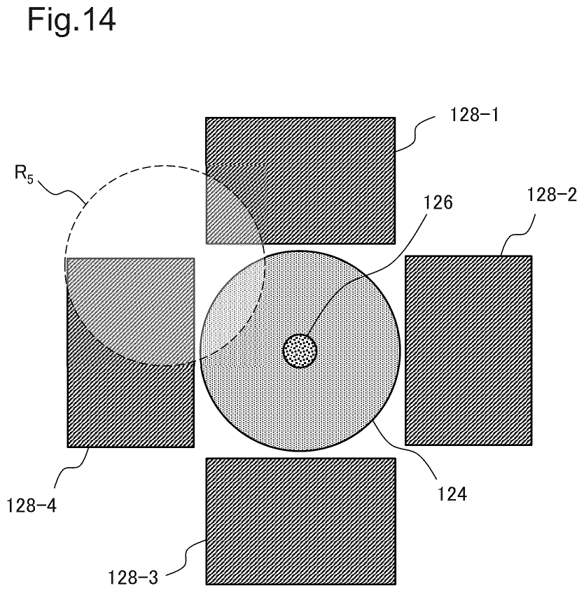

FIG. 14 illustrates an example in which an integration light receiving element 128 is disposed instead of the integration light receiving element 122. The integration light receiving element 128 has a larger light receiving area than the integration light receiving element 122. In FIG. 14, a number (1 to 8) is added to the end of the reference numeral representing each of the plurality of integration light receiving elements 128 to distinguish them from each other. In the example of FIG. 14, the signal light with which the light condensing range R₅ same as that in FIG. 12 is irradiated can be received by the two integration light receiving elements 128-1 and 128-4. In the example of FIG. 14, the signal light with which the light condensing range R₅ same as that in FIG. 13 is irradiated can be received in a wider area.

### (Modifications)

Next, modifications of the light receiver 12 included in the reception device 10 in the present disclosure will be described. Hereinafter, two modifications will be given.

### [First Modification]

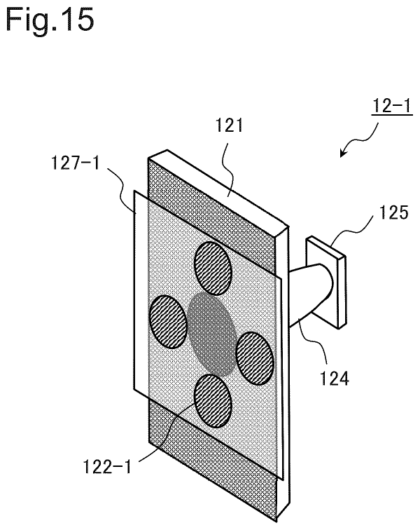

FIG. 15 is a conceptual diagram illustrating an example of a light receiver 12-1 according to the first modification. FIG. 15 is a view of the light receiving face of the light receiver 12-1 when viewed from obliquely above. In the light receiver 12-1, an integration light receiving element 122-1 is disposed instead of the integration light receiving element 122. For example, a germanium photodiode can be applied to the integration light receiving element 122-1. Compared with the InGaAs photodiode, the germanium photodiode can have a large light receiving area at lower cost. In the light receiver 12-1, a filter 127-1 that selectively transmits light in a wavelength band in which the InGaAs photodiode and the germanium photodiode have sensitivity is disposed. According to the present modification, the light receiving area of the integration light receiving element 122-1 can be increased.

### [Second Modification]

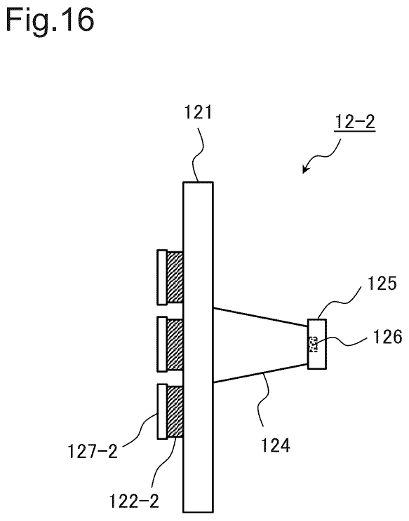

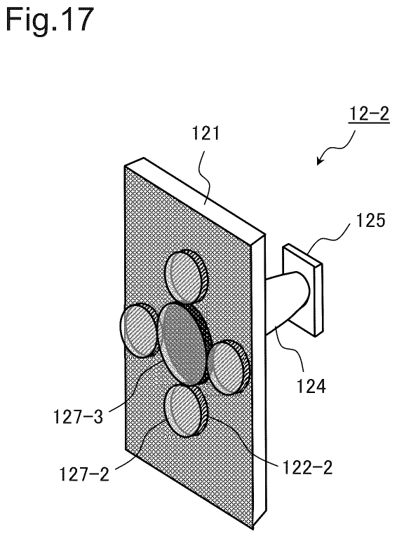

FIGS. 16 to 17 are conceptual diagrams illustrating an example of a light receiver 12-2 according to the second modification. FIG. 16 is a side view of the light receiver 12-2 when viewed from a side. FIG. 17 is a view of the light receiving face of the light receiver 12-2 when viewed from obliquely above. In the light receiver 12-2, an integration light receiving element 122-2 is disposed instead of the integration light receiving element 122. The integration light receiving element 122-2 and the communication light receiving element 125 have different wavelength bands having sensitivity. For example, a silicon photodiode can be applied to the integration light receiving element 122-2. The silicon photodiode has sensitivity in a wavelength band near 850 nanometers (nm). On the other hand, the InGaAs photodiode and the germanium photodiode have sensitivity in a wavelength band near 1550 nm. In the light receiver 12-2, a filter 127-2 that selectively transmits light in a wavelength band in which a silicon photodiode has sensitivity is disposed. The filter 127-2 is shaped and sized to fit the light receiving face of the light receiver 12-2. A filter 127-3 that selectively transmits light in a wavelength band in which the InGaAs photodiode has sensitivity is disposed in the light receiver 12-2. The filter 127-3 is shaped and sized to fit the first opening end of the light guide tube 124. According to the present modification, photodiodes sensitive to different wavelength bands can be applied to the integration light receiving element 122-2 and the communication light receiving element 125.

As described above, the reception device according to the present example embodiment includes a ball lens, at least one light receiver, a support column, and a controller. The light receiver includes a substrate, a plurality of integration light receiving elements, a light guide tube, and a communication light receiving element. The substrate has a first face facing the ball lens and a second face facing the first face. The substrate has a through hole penetrating the first face and the second face. The plurality of integration light receiving elements is disposed around the through hole on the first face of the substrate with the light reception part facing the ball lens. The light guide tube includes a first opening end associated with the through hole and a second opening end facing the first opening end. The light guide tube is disposed, on the side of the second face of the substrate, to coincide with the position of the through hole. The communication light receiving element is disposed at the second opening end of the light guide tube with the light reception part facing the ball lens. The light receiver is movably supported around the ball lens by the support column. The controller receives electric signals based on signal light received by the plurality of integration light receiving elements and the communication light receiving element. The controller adjusts the angle of the light receiving face of the light receiver and the position of the support column according to the received electric signal. The controller adjusts the angle of the light receiving face of the light receiver and the position of the support column according to the intensity of the signal light received by each of the plurality of integration light receiving elements, and adjusts the position of the light reception part of the communication light receiving element in accordance with the condensing position of the signal light condensed by the ball lens.

According to the reception device of the present example embodiment, the light receiving face of the light receiver can be oriented in an azimuth of 360 degrees by moving the light receiver around the ball lens. The reception device according to the present example embodiment adjusts the position of the light reception part of the communication light receiving element in accordance with the condensing position of the signal light condensed by the ball lens according to the intensity of the signal light received by each of the plurality of integration light receiving elements. That is, according to the present example embodiment, a communication angle of 360 degrees can be achieved.

In an aspect of the present example embodiment, the plurality of integration light receiving elements is disposed in a point-symmetric positional relationship with respect to the center of the through hole. The light reception part of the communication light receiving element is disposed to be aligned with the condensing point of the ball lens. According to the present aspect, since the communication light receiving element is disposed at the position of the condensing point where the intensity of the signal light condensed by the ball lens is high, the light receiving efficiency of the signal light by the communication light receiving element is improved.

In an aspect of the present example embodiment, the plurality of integration light receiving elements is disposed in a point-symmetric positional relationship with respect to the center of the through hole. The controller moves the angle of the light receiving face of the light receiver and the position of the support column toward a direction of the integration light receiving element whose reception intensity is higher according to the intensity of the signal light received by each of the plurality of integration light receiving elements. According to the present aspect, the position of the communication light receiving element can be moved toward the center of the condensing region by the ball lens according to the intensity of the signal light received by each of the plurality of integration light receiving elements. Therefore, according to the present aspect, the light receiving efficiency of the signal light by the communication light receiving element can be improved.

In an aspect of the present example embodiment, a filter that selectively transmits light in a wavelength band of a spatial optical signal to be received is disposed in association with light reception parts of a plurality of integration light receiving elements and communication light receiving elements. According to the present aspect, signal light in a wavelength band in which each light receiving element has sensitivity can be selectively supplied to each of the light reception parts of the plurality of integration light receiving elements and the communication light receiving elements. According to the present aspect, since an optical signal from which disturbance light such as sunlight is removed is supplied, the light receiving efficiency of the integration light receiving element and the communication light receiving element can be improved.

In an aspect of the present example embodiment, the integration light receiving element and the communication light receiving element are light receiving elements having sensitivity to light in different wavelength bands. For example, a relatively inexpensive silicon-based or germanium-based photodiode can be applied to the integration light receiving element, and a high-performance InGaAs-based photodiode can be applied to the communication light receiving element. With this configuration, the cost of the light receiver can be reduced.

### Second Example Embodiment

Next, a communication device according to a second example embodiment will be described with reference to the drawings. The communication device of the present example embodiment includes the reception device according to the first example embodiment. Hereinafter, an example in which the communication device of the present example embodiment includes a transmission device including a spatial light modulator will be described. The communication device of the present example embodiment may have a light transmission function that is not a spatial light modulator.

### (Configuration)

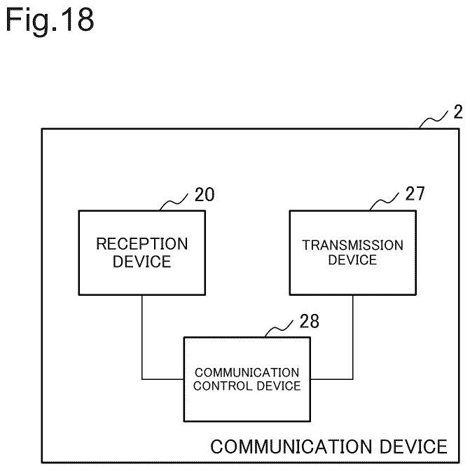

FIG. 18 is a block diagram illustrating an example of a configuration of a communication device in the present disclosure. The communication device 2 includes a reception device 20, a transmission device 27, and a communication control device 28. The reception device 20 has a configuration similar to that of the reception device 10 of the first example embodiment. Therefore, the description of the reception device 20 will be simplified below.

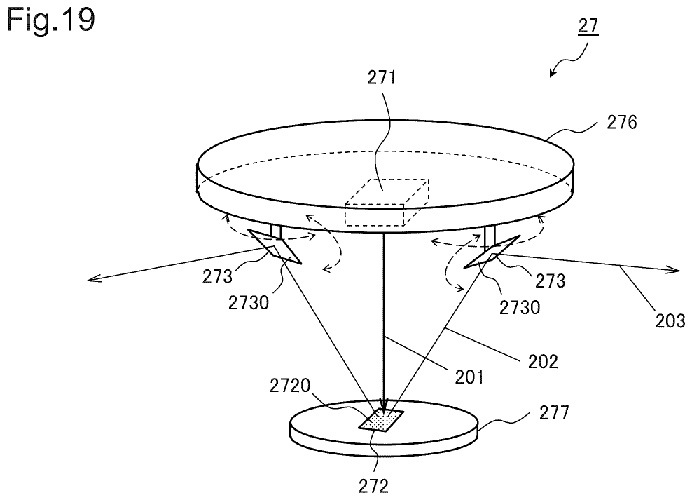

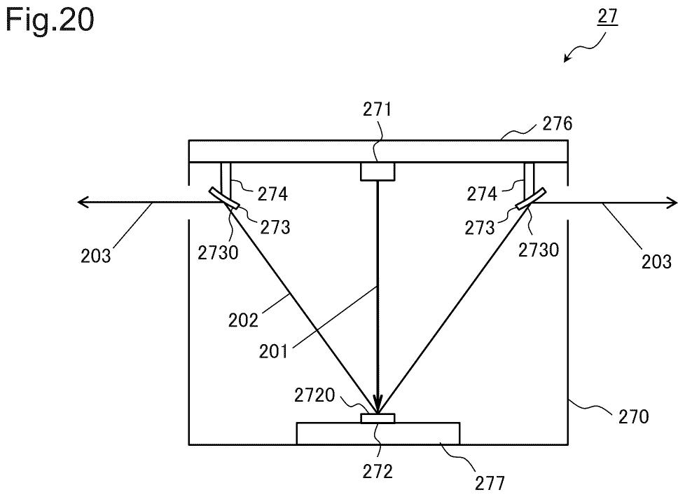

FIGS. 19 to 20 are conceptual diagrams illustrating an example of a configuration of the transmission device 27. FIG. 19 is a diagram of the internal configuration of the transmission device 27 when viewed from obliquely above. FIG. 20 is a diagram of the inside of a housing 270 of the transmission device 27 when viewed from a side. The transmission device 27 includes a light source 271, a spatial light modulator 272, and a light transmission mirror 273. An opening through which projection light 203 passes is formed in part of a side face of housing 270. A window made of a material that transmits light to be transmitted in a wavelength band of a spatial optical signal to be transmitted may be formed in the opening portion. FIGS. 19 to 20 are diagrams conceptually illustrating the transmission device 27, and do not accurately illustrate the arrangement and positional relationship of the components included in the transmission device 27.

The light source 271 is disposed on the lower face of a top plate 276 disposed on the upper portion of the housing 270 with the emission face facing downward. The emission face of the light source 271 is directed to a modulation part 2720 of the spatial light modulator 272 disposed below. The light source 271 may be disposed inside a through hole (not illustrated) formed in the top plate 276. The light source 271 may be disposed above the through hole formed in the top plate 276.

The light source 271 includes at least one emitter (not illustrated). The at least one emitter emits illumination light 201 under the control of the communication control device 28. The illumination light 201 emitted from the light source 271 is radiated to the modulation part 2720 of the spatial light modulator 272. For example, each of the plurality of emitters is associated with at least one of the plurality of modulation regions set in the modulation part 2720 of the spatial light modulator 272. The illumination light 201 emitted from each of the plurality of emitters travels toward the associated modulation region.

For example, the light source 271 includes a plurality of emitters that emit the illumination light 201 in the same wavelength band. For example, the light source 271 may be achieved by a laser array in which a plurality of emitters is disposed in an array. For example, a laser array has a plurality of emitters disposed in 4 rows×2 columns. For example, the light source 271 may be a combination of a plurality of emitters that emit illumination light in the same wavelength band and an emitter that emits illumination light in a wavelength band different from that of the plurality of emitters. For example, the light source 271 may have a configuration in which an emitter that emits illumination light 201 in a wavelength band used for communication with a communication target and an emitter that emits light in a wavelength band different from the wavelength band of the illumination light 201 are combined. For example, one of the plurality of emitters constituting the laser array is a search emitter, and the others are communication emitters. For example, the search emitter emits light in a wavelength band of 850 nm, and the communication emitter emits light in a wavelength band of 1550 nm. When the laser array is configured as described above, search is performed using the search emitter (850 nm), and when the search is completed, communication can be switched to communication using the communication emitter (1550 nm).

For example, an emitter included in the light source 271 emits laser light in a predetermined wavelength band. The wavelength of the laser light emitted from the emitter is not particularly limited, and may be selected according to the application. For example, the emitter emits the laser light in the visible or infrared wavelength band. For example, in the case of near infrared rays of 800 to 1000 nm, since the laser class can be increased as compared with visible light, the sensitivity can be improved as compared with visible light. For example, a laser light source having a higher output can be used for infrared rays in a wavelength band of 1.55 micrometers (μm) than near-infrared rays of 800 to 1000 nm. As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set. For example, the emitter may be achieved by a face light emitting element such as a photonic crystal surface emitting laser (PCSEL) type laser.

The spatial light modulator 272 is a phase modulation type spatial light modulator. The spatial light modulator 272 includes the modulation part 2720. The spatial light modulator 272 is disposed below the light source 271. In the example of FIG. 19, the spatial light modulator 272 is disposed on the upper face of a bottom plate 277. The spatial light modulator 272 is disposed at a position where the modulated light 202 obtained by modulating the illumination light 201 emitted from the light source 271 is reflected toward a reflection surface 2730 of the light transmission mirror 273. The traveling direction of the modulated light 202 is controlled according to the pattern (phase image) set by the modulation part 2720.

For example, the spatial light modulator 272 is achieved by a spatial light modulator using ferroelectric liquid crystal, homogeneous liquid crystal, vertical alignment liquid crystal, or the like. For example, the spatial light modulator 272 can be achieved by liquid crystal on silicon (LCOS). The spatial light modulator 272 may be achieved by a micro electro mechanical system (MEMS). In the phase modulation type spatial light modulator 272, the energy can be concentrated on the portion of the image by operating to sequentially switch the portion used for the projection of the projection light 203. Therefore, in the case of using the phase modulation type spatial light modulator 272, when the outputs of the emitters included in the light source 271 are the same, the image can be displayed brighter than other methods.

At least one modulation region is set in the modulation part 2720 of the spatial light modulator 272. The number of modulation regions set in the modulation part 2720 is set in accordance with the number of emitters included in the light source 271. Each of the plurality of modulation regions is associated with one of the plurality of emitters included in the light source 271. Each of the plurality of modulation regions is irradiated with illumination light 201 derived from the laser light emitted from the associated emitter. However, the relevant relationship between the modulation region and the emitter is not particularly limited as long as the illumination light 201 derived from the laser light emitted from the emitter is incident on the modulation face of the modulation region. The number of modulation regions set in the modulation part 2720 may be different from the number of emitters included in the light source 271.

The modulation region is divided into a plurality of regions (also referred to as tiling). A phase image is assigned to each of the plurality of tiles. Each of the plurality of tiles includes a plurality of pixels. A phase image related to a projected image is set to each of the plurality of tiles. A phase image is tiled to each of the plurality of tiles allocated to the modulation region. For example, a phase image generated in advance is set in each of the plurality of tiles. When the modulation region is irradiated with the illumination light 201 in a state where the phase image is set to the plurality of tiles, the modulated light 202 that forms an image related to the phase image of each tile is emitted. As the number of tiles set in the modulation region increases, a clear image can be displayed. However, when the number of pixels of each tile decreases, the resolution decreases. Therefore, the size and the number of tiles set in the modulation region are set according to the application.

A pattern (also referred to as a phase image) related to the image displayed by the projection light 203 is set in each of the plurality of modulation regions under the control of the communication control device. A pattern (phase image) is set in each of the plurality of modulation regions. The illumination light 201 with which each of the plurality of modulation regions is irradiated is modulated according to a pattern (phase image) set in the modulation region. The modulated light 202 modulated in each of the plurality of modulation regions travels toward the reflection surface 2730 of the light transmission mirror 273.

For example, a shielder (not illustrated) may be disposed at a subsequent stage of the spatial light modulator 272. The shielder is a frame that shields unnecessary light components included in the modulated light 202 and defines an outer edge of a display region of the projection light 203. For example, the shielder is an aperture. In such an aperture, a slit-shaped opening is formed in a portion through which light (desired light) that forms a desired image passes. The desired light is first-order diffracted light. The shielder pass the desired light and shield unwanted light components. For example, the shielder shields a ghost image including 0th-order light included in the modulated light 202, and unnecessary first order light, and high order light above second order appearing at a point-symmetric position with respect to desired light with the 0th-order light as the center. Details of the shielder will not be described.

The light transmission mirror 273 is a reflector having a reflection surface 2730. The reflection surface 2730 may be a flat face or may have a curvature related to a projection angle of the projection light 203. For example, the reflection surface 2730 may have a shape in which a curved surface and a flat face are combined. The light transmission mirror 273 is disposed at a subsequent stage of the spatial light modulator 272. The light transmission mirror 273 is disposed at the lower end of a hanging column 274 suspended from the top plate 276. The light transmission mirror 273 is installed movably in a horizontal plane by a movement mechanism (not illustrated). The reflection surface 2730 of the light transmission mirror 273 is installed in such a way that the angle can be changed by an angle adjustment mechanism (not illustrated). The position of the light transmission mirror 273 and the angle of the reflection surface 2730 are changed according to the control by the communication control device 28. The communication control device 28 changes the position of the light transmission mirror 273 and the angle of the reflection surface 2730 in such a way that the reflection surface 2730 faces the incoming direction of the spatial optical signal transmitted from the communication target.

The light transmission mirror 273 is disposed in such a way that the reflection surface 2730 is directed obliquely with respect to the modulation part 2720 of the spatial light modulator 272. The light transmission mirror 273 is disposed in the optical path of the modulated light 202. The reflection surface 2730 of the light transmission mirror 273 is irradiated with the modulated light 202. The light (projection light 203) reflected by the reflection surface 2730 is projected as a spatial optical signal. Projection light 203 is projected in a direction related to an irradiation position of modulated light 202 on reflection surface 2730 of the light transmission mirror 273. The light (projection light 203) reflected by the reflection surface 2730 is enlarged and projected at an enlargement ratio related to the curvature of the reflection surface 2730. For example, in order to adjust the spread of the projection light 203, a lens (not illustrated) may be disposed at a subsequent stage of the light transmission mirror 273.

The reflection surface 2730 of the light transmission mirror 273 is directed in an any direction (360 degrees) in the horizontal plane according to the position of the hanging column 274 holding the light transmission mirror 273. Therefore, the transmission device 27 can project the projection light 203 in the direction of 360 degrees in the horizontal plane by controlling the pattern (phase image) set in the modulation part 2720 of the spatial light modulator 272. The transmission device 27 can simultaneously transmit the projection light 203 (spatial optical signal) toward the communication target disposed in the plurality of directions by associating the plurality of modulation regions set in the modulation part 2720 with different directions. The communication control device 28 controls the projection direction of the projection light 203 in the vertical direction by adjusting the angle of the reflection surface 2730.

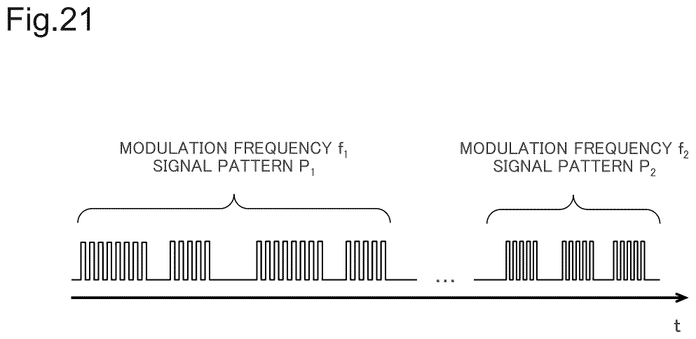

The transmission device 27 transmits the spatial optical signal in which at least two transmission patterns are combined according to the transmission direction of the search spatial optical signal. FIG. 21 is a conceptual diagram for describing a transmission pattern of the search spatial optical signal transmitted from the transmission device 27. The transmission pattern is set by a combination of a modulation frequency and a signal pattern. In the example of FIG. 21, the spatial optical signal is transmitted in two transmission patterns. The first transmission pattern has modulation frequency f₁ and signal pattern P₁. The second transmission pattern has modulation frequency f₂ and signal pattern P₂. The number of transmission patterns is not limited to two, and is set to an any number.

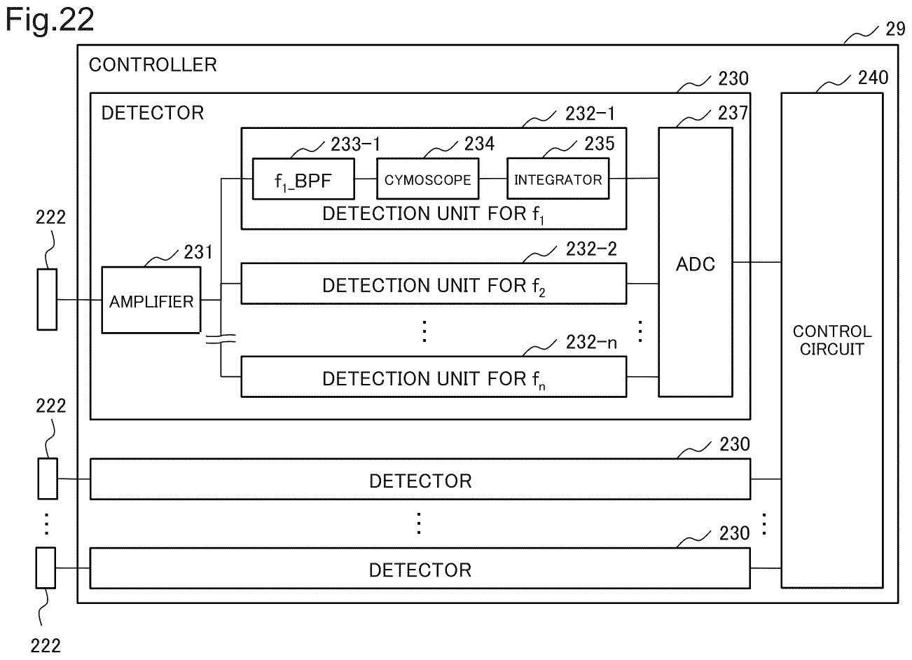

FIG. 22 is a block diagram illustrating an example of a configuration of a controller 29 included in the reception device 20. The controller 29 includes a plurality of detectors 230 and a control circuit 240. The plurality of detectors 230 is associated with the plurality of integration light receiving elements 222. The plurality of detectors 230 is connected to the control circuit 240. The plurality of detectors 230 has the same configuration. FIG. 22 illustrates an internal configuration of the uppermost detector 230. The controller 29 may be configured in the communication control device 28.

The detector 230 includes an amplifier 231, a plurality of detection units 232, and an analog-to-digital conversion circuit ADC 237 (Analog-to-Digital Converter (ADC)). The plurality of detection units 232 includes a band pass filter (BPF) related to a frequency band to be received. The BPF cuts a signal derived from ambient light such as sunlight.

The amplifier 231 is connected to an integration light receiving element 222. An electric signal related to the signal light received by the integration light receiving element 222 is input to the amplifier 231. The amplifier 231 amplifies the input electric signal with a set amplification factor. The amplification factor of the amplifier 231 can be set to any factor. The electric signal amplified by the amplifier 231 is output to each of the plurality of detection units 232.

The plurality of detection units 232 is related to a frequency band to be received. The detector 230 includes detection units 232-1 to n related to the modulation frequency f₁, the modulation frequency f₂, . . . , and the modulation frequency fₙ (n is a natural number), respectively. The detection units 232-1 to n detect the signals of the modulation frequencies f₁ to fₙ, respectively. The signals of the modulation frequencies f₁ to fₙ detected by the detection units 232-1 to n, respectively, are supplied to the ADC 237.

The detection unit 232-1 includes a BPF (f₁_BPF 233-1) that selectively passes a signal of a modulation frequency f₁, a cymoscope 234, and an integrator 235. The detection unit 232-2 includes a BPF (not illustrated) that selectively passes a signal of a modulation frequency f₂, the cymoscope 234, and the integrator 235. The detection unit 232-n includes a BPF (not illustrated) that selectively passes a signal having a modulation frequency fₙ, the cymoscope 234, and the integrator 235. Hereinafter, among the detection units 232-1 to n, description of the detection units 232-2 to n will be omitted, and the detection unit 232-1 will be described.

f₁ BPF 233-1 is a filter that selectively passes a signal in the frequency band of the modulation frequency f₁. The signal that has passed through f₁_BPF 233-1 is supplied to the cymoscope 234.

The signal having the modulation frequency f₁ that has passed through the f₁_BPF 233-1 is input to the cymoscope 234. The cymoscope 234 detects a signal having the modulation frequency f₁. The signal detected by the cymoscope 234 is supplied to the integrator 235.

The integrator 235 acquires the signal output from the cymoscope 234. The integrator 235 integrates the acquired signal. The integrator 235 outputs the integrated signal to the ADC 237. As compared with the communication spatial optical signal (communication light), the scanning spatial optical signal (scanning light) has a weak intensity because the beam diameter is greatly expanded. Therefore, it is difficult to measure the voltage of the signal amplified only by the amplifier 231. By using the integrator 235, for example, the voltage of the signal can be increased to a measurable level by integrating the signal in a period of several milliseconds to several tens of milliseconds.

Each of the signals of the modulation frequencies f₁ to fₙ detected by the detection units 232-1 to n, respectively, is input to the ADC 237. The ADC 237 converts the input signal (analog signal) into a digital signal. The converted digital signal is output to the control circuit 240.

The control circuit 240 acquires the digital signal output from each of the plurality of detectors 230. The control circuit 240 outputs the acquired digital signal to the communication control device 28. The control of the light receiver described later may be executed by the control circuit 240.

The communication control device 28 acquires the digital signal output from the control circuit 240. The communication control device 28 calculates the reception intensity of the spatial optical signal for each integration light receiving element 222 with respect to the acquired digital signal. The communication control device 28 changes the position of the light receiving face of the light receiver (not illustrated) including the plurality of integration light receiving elements 222 in such a way that the reception intensities of the plurality of integration light receiving elements 222 become equal. By such control, the condensing position of the signal light condensed by the ball lens approaches the center of the plurality of integration light receiving elements 222. The signal light with which a region around the center of each of the plurality of integration light receiving elements 222 is irradiated is received by a communication light receiving element (not illustrated).

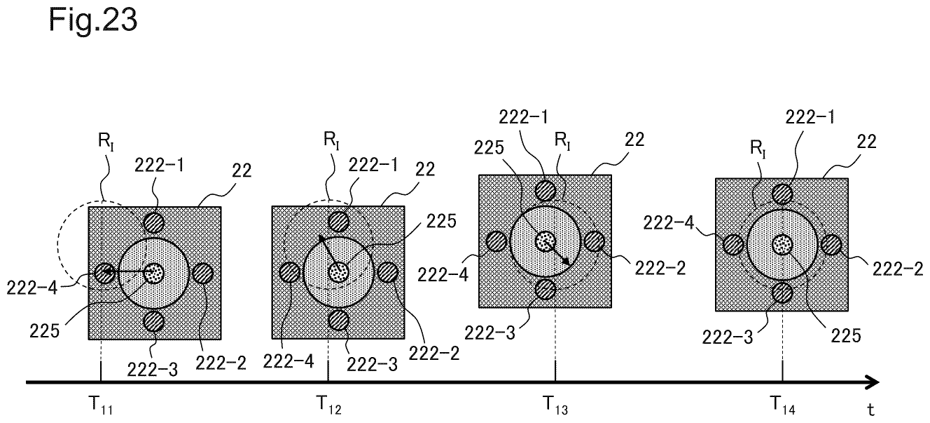

FIG. 23 is a conceptual diagram illustrating an example in which the position of the light receiver 22 is changed according to the intensity of the signal light received by the plurality of integration light receiving elements 222. FIG. 23 illustrates a change in the relative position of the light receiver 22 with respect to the light condensing range R₁ of the signal light condensed by the ball lens in time series. Hereinafter, an example of optimizing the position of the light receiver 22 based on the positional relationship on the paper surface will be described. In FIG. 23, a number (1 to 4) is added to the end of the reference numeral representing each of the plurality of integration light receiving elements 222 to distinguish them from each other.

At timing T₁₁, the signal light is received by the integration light receiving element 222-4. In this state, when the position of the light receiver 22 is moved to the left side, the communication light receiving element 225 approaches the center of the light condensing range R₁. Therefore, the communication control device 28 moves the position of the light receiver 22 to the left side in such a way that the communication light receiving element 225 is irradiated with the signal light.

At timing T₁₂, the signal light is received by the integration light receiving element 222-1, the integration light receiving element 222-4, and the communication light receiving element 225 according to the change in the position of the light receiver 22. In this state, when the position of the light receiver 22 is moved obliquely upward to the left, the communication light receiving element 225 approaches the center of the light condensing range R₁. Therefore, the communication control device 28 moves the position of the light receiver 22 obliquely upward to the left in such a way that the communication light receiving element 225 is irradiated with the signal light.

At timing T₁₃, the signal light is received by the integration light receiving element 222-2, the integration light receiving element 222-3, and the communication light receiving element 225 according to the change in the position of the light receiver 22. In this state, when the position of the light receiver 22 is moved obliquely downward to the right, the communication light receiving element 225 approaches the center of the light condensing range R₁. Therefore, the communication control device 28 moves the position of the light receiver 22 obliquely downward to the right in such a way that the communication light receiving element 225 is irradiated with the signal light. At this time, the communication control device 28 shortens the movement distance of the light receiver 22 as compared with the transition from timing T₁₂ to timing T₁₃.

At timing T₁₄, the signal light is received by all the integration light receiving elements 222-1 to 4 and the communication light receiving element 225 according to the change in the position of the light receiver 22. This state is a state in which the communication light receiving element 225 substantially coincides with the center of the light condensing range R₁. In this state, the spatial optical signal transmitted from the communication target can be efficiently received by the communication light receiving element 225.

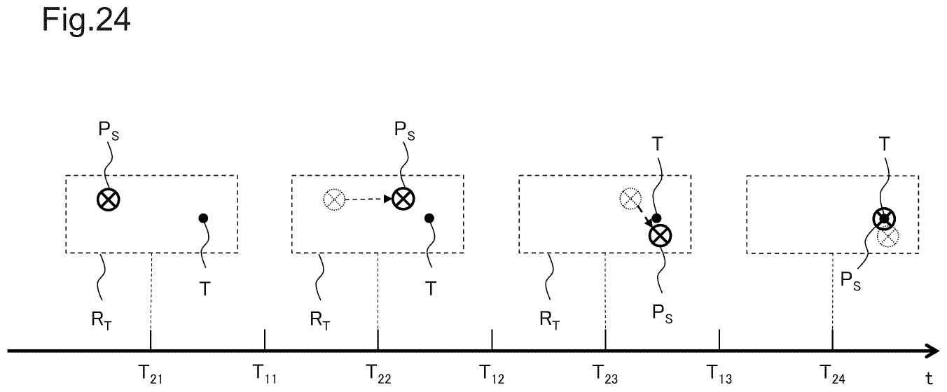

FIG. 24 is a conceptual diagram illustrating an example of changing the transmission direction of the spatial optical signal transmitted from the transmission device 27. FIG. 24 illustrates an example in which calibration for obtaining the relationship between the direction of the light receiving face of the light receiver 22 and the transmission direction of the spatial optical signal is performed in advance, and the transmission direction of the spatial optical signal is optimized in accordance with the movement of the light receiver 22. The time-series change illustrated in FIG. 24 is associated with the time-series change illustrated in FIG. 23. The communication control device 28 moves the communication light receiving element 225 toward the center of the light condensing range R₁ according to the intensity of the signal light received by each of the plurality of integration light receiving elements 222-1 to 4. The communication control device 28 changes the transmission direction of the spatial optical signal transmitted from the transmission device 27 in accordance with the movement of the communication light receiving element 225.

As described above, when the transmission direction of the spatial optical signal is changed in accordance with the movement of the communication light receiving element 225 toward the center of the light condensing range R₁, the transmission direction of the spatial optical signal can be more accurately adjusted toward the communication target T. FIG. 24 illustrates a change in the relative position of the irradiation position PS of the spatial optical signal in the light condensing range R_{T} of the spatial optical signal transmitted from the transmission device 27 in time series. Hereinafter, an example of optimizing the transmission direction of the spatial optical signal based on the positional relationship in the paper surface will be described.

Timing T₂₁ is a timing preceding timing T₁₁. The irradiation position P_{S} of the spatial optical signal is located left of the communication target T. In accordance with the reception situation of the signal light at timing T₁₁, the communication control device 28 moves the transmission direction of the spatial optical signal to the right in such a way that the spatial optical signal is received by the communication target T.

Timing T₂₂ is a timing subsequent to timing T₁₁. The irradiation position P_{S} of the spatial optical signal is obliquely upward to the left with respect to the communication target T. In accordance with the reception situation of the signal light at timing T₁₂, the communication control device 28 moves the transmission direction of the spatial optical signal obliquely downward to the right in such a way that the spatial optical signal is received by the communication target T.

Timing T₂₃ is a timing subsequent to timing T₁₂. The irradiation position P_{S} of the spatial optical signal is located slightly below the communication target T. In accordance with the reception situation of the signal light at timing T₁₃, the communication control device 28 moves the transmission direction of the spatial optical signal slightly upward in such a way that the spatial optical signal is received by the communication target T.

Timing T₂₄ is a timing subsequent to timing T₁₃. This state is a state in which the irradiation position P_{S} of the spatial optical signal substantially coincides with the communication target T. In this state, the spatial optical signal transmitted from the transmission device 27 is efficiently received by the communication target.

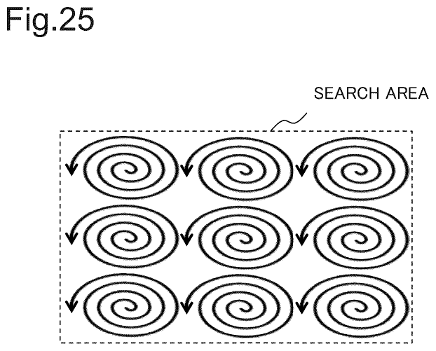

FIG. 25 is a conceptual diagram for describing a transmission example of a scanning spatial optical signal (scanning light). The transmission device 27 controls the transmission direction of the scanning light by controlling the phase image set in the modulation part 2720 of the spatial light modulator 272. The transmission device 27 divides the search range of the communication target into several sub-regions to transmit the scanning light. In the example of FIG. 25, the search range is divided into nine sub-regions, and the scanning light is transmitted for each sub-region. For a single sub-region, the transmission device 27 transmits the scanning light while changing the transmission direction spirally from the center of the sub-region. That the scanning light is transmitted in a spiral shape is an example, and the method of transmitting the scanning light is not limited. When the light reaches the boundary of the sub-region, the transmission device 27 similarly transmits the scanning light for the other sub-regions. For example, the transmission device 27 transmits the scanning light in the order of center, left, right, upper, lower, upper left, upper right, lower left, and lower right with respect to the plurality of sub-regions included in the search range. In the step of transmitting the scanning light, the scanning light is transmitted in a direction in which the communication target is assumed to be located. Therefore, the probability that the communication target is located at a position close to the center of the search area is high. Therefore, the transmission direction of the scanning light is sequentially switched from the central sub-region to the peripheral sub-region. The order of the sub-regions to which the scanning light is transmitted may be set to any order.

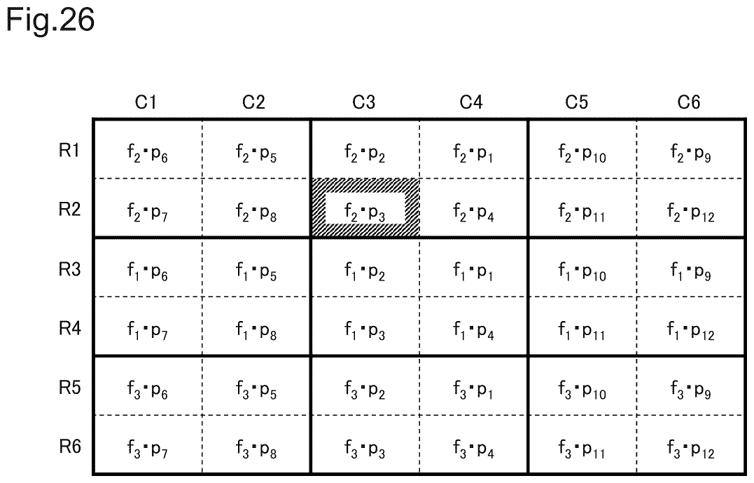

FIG. 26 is a diagram for describing an example of a transmission pattern of the spatial optical signal transmitted from the transmission device 27. FIG. 26 illustrates a search range of the scanning light transmitted from the transmission device 27. In FIG. 26, the search range is divided into nine sub-regions. Each of the nine sub-regions is further divided into four small regions. That is, the search range is divided into 36 small regions. The small region is expressed by a combination of row symbols and column symbols. For example, the small region at the position of the row R₁ and the column C1 is expressed as a small region R1C1.

A transmission pattern in which a unique modulation frequency and a unique signal pattern are combined is set in each of the plurality of small regions. A modulation frequency f₂ is set in the row R1 and the row R2. A modulation frequency f₁ is set in the row R3 and the row R4. A modulation frequency f₃ is set in the row R5 and the row R6. For example, a spatial optical signal of a transmission pattern in which the modulation frequency f₂ and the signal pattern P₆ are combined is transmitted to the small region R1C1. The transmission pattern of the spatial optical signal transmitted to the plurality of small regions is set to a unique pattern for each small region. The communication target located within the search range receives the spatial optical signal of the transmission pattern associated with the small region. In FIG. 26, it is assumed that the communication target is located at the position of the small region R2C3.

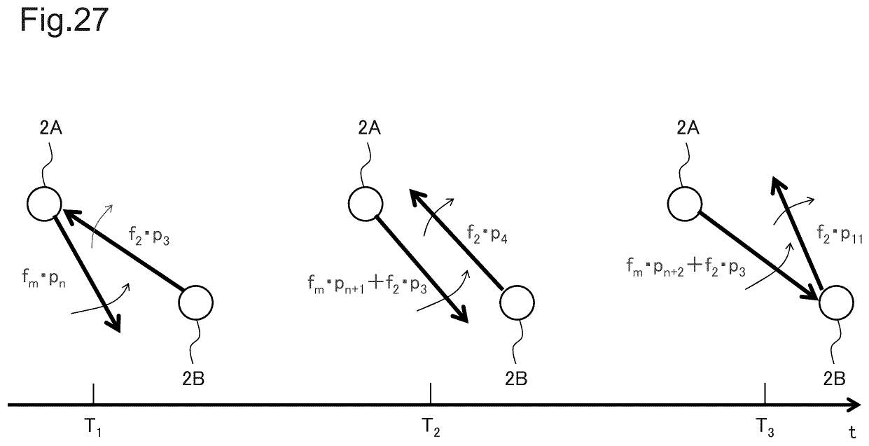

FIG. 27 is a conceptual diagram for describing an example of communication establishment between a communication device 2A and a communication device 2B. FIG. 27 illustrates a change in the transmission direction of the spatial optical signal according to a temporal change in time series.

At timing T₁, the communication device 2A transmits the spatial optical signal of the signal pattern pₙ modulated at the modulation frequency fₘ. The communication device 2B transmits the spatial optical signal of the signal pattern p₃ modulated at the modulation frequency f₂. At timing T₁, the communication device 2A receives the spatial optical signal transmitted from the communication device 2B. The communication device 2A receives the spatial optical signal of the signal pattern p₃ modulated at the modulation frequency f₂.

At timing T₂, the communication device 2A transmits a spatial optical signal in which the signal pattern pₙ₊₁ modulated at the modulation frequency fₘ and the signal pattern p₃ modulated at the modulation frequency f₂ are combined. The communication device 2B transmits the spatial optical signal of the signal pattern p₄ modulated at the modulation frequency f₂.

At timing T₃, the communication device 2A transmits a spatial optical signal in which the signal pattern pₙ₊₂ modulated at the modulation frequency fₘ and the signal pattern p₃ modulated at the modulation frequency f₂ are combined. The communication device 2B transmits the spatial optical signal of the signal pattern p₁₁ modulated at the modulation frequency f₂. At timing T₃, the communication device 2B receives the spatial optical signal transmitted from the communication device 2A. The communication device 2B receives a spatial optical signal in which the signal pattern pₙ₊₂ modulated at the modulation frequency fₘ and the signal pattern p₃ modulated at the modulation frequency f₂ are combined. At this point, the communication device 2B identifies that the spatial optical signal transmitted toward the small region R2C3 is received by the communication device 2B. The communication device 2B transmits a spatial optical signal in which the signal pattern p₃ modulated at the modulation frequency f₂ and the signal pattern pₙ₊₂ modulated at the modulation frequency fₘ are combined toward the identified small region R2C3. When the spatial optical signal in which the signal pattern p₃ modulated at the modulation frequency f₂ and the signal pattern pₙ₊₂ modulated at the modulation frequency fₘ are combined is received by the communication device 2A, the communication device 2A and the communication device 2B share the positional relationship with each other.

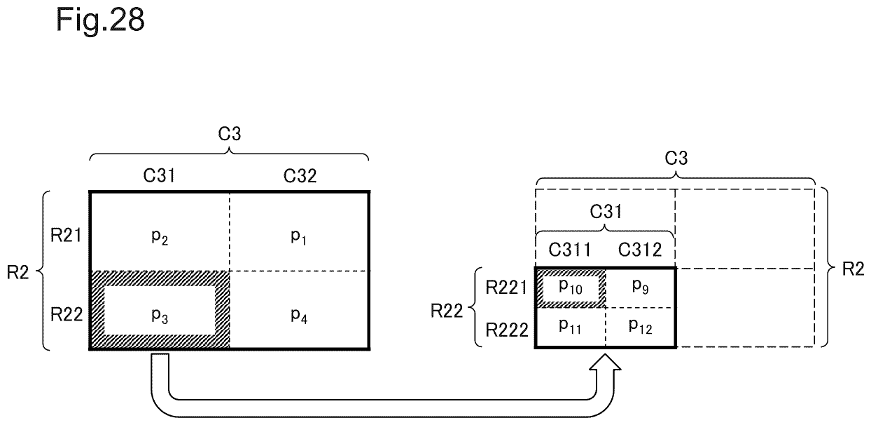

FIG. 28 is a conceptual diagram for describing a process of optimizing the transmission direction of the spatial optical signal transmitted from the communication device 2B toward the communication device 2A. In the examples of FIGS. 26 to 27, when the communication device 2B identifies that the communication device 2A is located in the direction of the small region R2C3, the communication device 2B divides the small region R2C3 into further small regions. In the example of FIG. 28, the small region R2C3 is divided into four small regions. The communication device 2B transmits the spatial optical signal having the reduced beam diameter to each of the four small regions in different signal patterns. In the stage of FIG. 28, since the position of the communication device 2A in the column direction is identified, the communication device 2B does not need to change the modulation frequency of the spatial optical signal. For example, the communication device 2B transmits a spatial optical signal modulated at the modulation frequency f₄. In the example of FIG. 28, the communication device 2A is located in the direction of the small region R22C31.

When the communication device 2B identifies that the communication device 2A is located in the direction of the small region R22C31, the communication device 2B divides the small region R22C31 into further small regions. In the example of FIG. 28, the small region R22C31 is divided into four small regions. The communication device 2B transmits the spatial optical signal in which the beam diameter is further reduced to each of the four small regions in different signal patterns. For example, the communication device 2B transmits a spatial optical signal modulated at the modulation frequency f₄. In the example of FIG. 28, the communication device 2A is located in the direction of the small region R221C311. In this way, by repeating the division of the small region, the direction of the communication target can be identified more accurately.

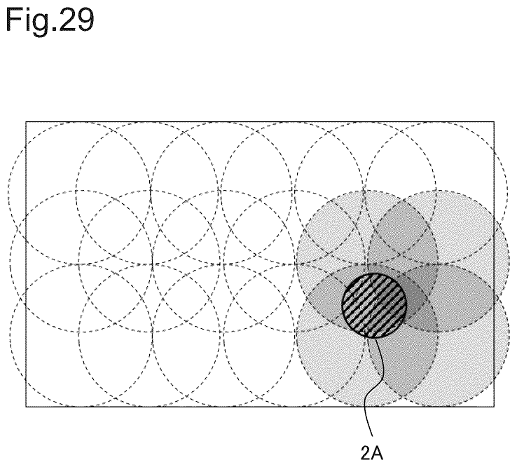

FIG. 29 is a conceptual diagram for describing that after the position of the communication device 2A is identified by the scanning light, the communication device 2B identifies the accurate position using the communication light. In the example of FIG. 29, hatched beams are received by the communication device 2A. In the stage of FIG. 29, the communication device 2A can be scanned using communication light having a small beam diameter. By using the communication light, more information can be transmitted and received. Therefore, the communication device 2B can accurately identify the position of the communication device 2A using the communication light.

### (Operation)

Next, an example of an operation of the communication device 2 will be described with reference to the drawings. Hereinafter, an example of control of the reception device 20 and the transmission device 27 by the communication control device 28 will be described. In the following description, the communication control device 28 is an operation subject.

### [Reception Device]

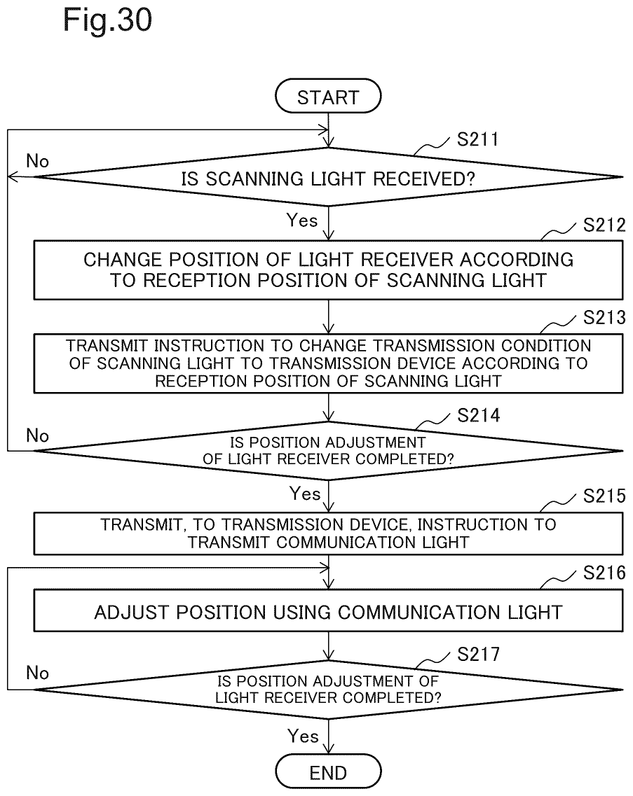

FIG. 30 is a flowchart for describing an example of control of the reception device 20 by the communication control device 28.

In FIG. 30, when the scanning light from the communication target is received (Yes in step S211), the communication control device 28 changes the position of the light receiver according to the reception position of the scanning light from the communication target (step S212). When the scanned light from the communication target has not been received (No in step S211), the communication control device 28 waits for reception of the scanned light.

After step S212, the communication control device 28 transmits an instruction to change the transmission condition of the scanning light to the transmission device according to the reception position of the scanning light from the communication target (step S213).

When the position adjustment of the light receiver using the scanning light is not completed (No in step S214), the process returns to step S211. When the position adjustment of the light receiver using the scanning light is completed (Yes in step S214), the communication control device 28 transmits, to the transmission device, an instruction to transmit a communication light (step S215).

Next, the communication control device 28 performs position adjustment using the communication light (step S216).

When the position adjustment of the light receiver using the communication light is not completed (No in step S217), the process returns to step S215. When the position adjustment of the light receiver using the communication light is completed (Yes in step S217), the processing along the flowchart in FIG. 30 is ended.

### [Transmission Device]

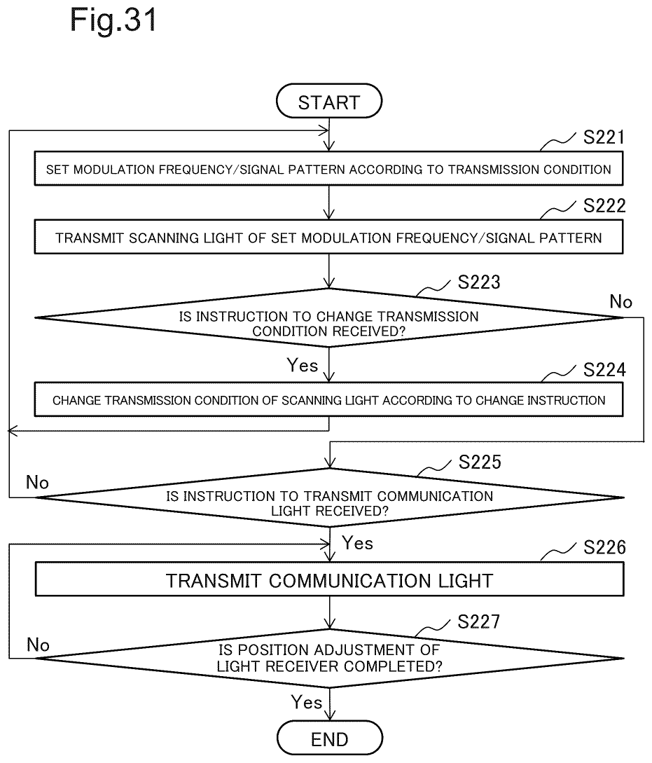

FIG. 31 is a flowchart for describing an example of control of the transmission device 27 by the communication control device 28.

In FIG. 31, first, the communication control device 28 sets a modulation frequency/signal pattern according to the transmission direction (step S221).

Next, the communication control device 28 transmits the scanning light of the set modulation frequency/signal pattern (step S222).

When the instruction to change the transmission condition of the scanning light is received (Yes in step S223), the communication control device 28 changes the transmission condition of the scanning light in response to the change instruction (step S224). After step S224, the process returns to step S221.

When the instruction to change the transmission condition of the scanning light has not been received (No in step S223), the communication control device 28 executes processing (step S225) according to the presence or absence of reception of a signal instructing transmission of the communication light. When the instruction to transmit the communication light has not been received (No in step S225), the process returns to step S221.

When receiving the instruction to transmit the communication light (Yes in step S225), the communication control device 28 causes the transmission device 27 to transmit the communication light (step S226).

When the position adjustment of the light receiver using the communication light is not completed (No in step S227), the communication control device 28 continues the transmission of the communication light by the transmission device 27 (step S226). When the position adjustment of the light receiver using the communication light is completed (Yes in step S227), the processing along the flowchart in FIG. 31 is ended.

As a result of the processing in FIGS. 30 to 31, communication between the communication device 2 and the communication target is established. The description of the communication between the communication device 2 and the communication target will be omitted.

As described above, the communication device according to the present example embodiment includes the reception device, the transmission device, and the communication control device. The reception device has the configuration of the first example embodiment. The transmission device transmits a spatial optical signal. The communication control device controls the position and angle of the light receiver and the transmission direction of the spatial optical signal transmitted from the transmission device according to the light receiving position of the spatial optical signal received by the light receiver of the reception device. According to the present aspect, a communication angle of 360 degrees can be achieved by controlling the position and angle of the light receiver of the reception device and the transmission direction of the spatial optical signal transmitted from the transmission device according to the light receiving position of the spatial optical signal.

In an aspect of the present aspect, the communication control device causes the transmission device to transmit the search spatial optical signal of the transmission pattern in which the modulation frequency and the signal pattern that vary depending on the transmission direction of the spatial optical signal are combined in association with the transmission direction. In response to the reception by the reception device of the search spatial optical signal transmitted from the communication target, the communication control device causes the transmission device to transmit the spatial optical signal to which the transmission pattern of the received search spatial optical signal is added in association with the transmission direction. The communication device according to the present aspect acquires a transmission pattern of the search spatial optical signal transmitted from the communication target. By the communication device of the present aspect returning the transmission pattern of the received search spatial optical signal to the communication target, the communication target can identify that the spatial optical signal transmitted in which direction is received by the communication device. When the communication target transmits the spatial optical signal in the identified direction, the communication establishment process can be executed between the communication device and the communication target.

In an aspect of the present aspect, the communication control device causes the reception device to change the position of the light receiver in response to reception by the reception device of the search spatial optical signal transmitted from the communication target. The communication control device causes the reception device to change the position of the light receiver according to the intensity of the signal light based on the search spatial optical signal received by each of the plurality of integration light receiving elements included in the reception device. The communication control device transmits an instruction to change the transmission condition of the search spatial optical signal to the transmission device. According to the present aspect, the position of the light receiver and the transmission direction of the search spatial optical signal can be adjusted according to the intensity of the signal light received by each of the plurality of integration light receiving elements.

In an aspect of the present aspect, the communication control device executes detailed scanning using the communication light receiving element in response to completion of position adjustment of the light receiver using the integration light receiving element. When the mutual directions are identified between the communication target and the communication device, the communication control device causes the transmission device to transmit the search spatial optical signal in which the search range and the beam diameter are narrowed. According to the present aspect, the position of the communication target can be accurately identified by narrowing the search range and the beam diameter of the search spatial optical signal transmitted and received between the communication targets. Furthermore, according to the present aspect, the light receiving efficiency of the optical signal by the communication light receiving element can be optimized by executing detailed scanning using the communication light receiving element.

### Third Example Embodiment

Next, a reception device according to the third example embodiment will be described with reference to the drawings. The reception device of the present example embodiment has a configuration in which the reception devices of the first and the second example embodiments are simplified.

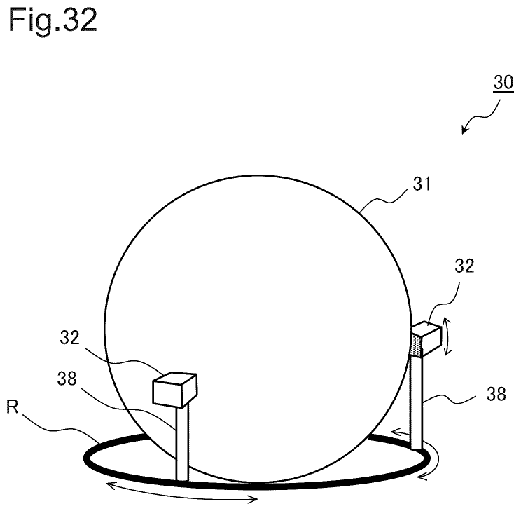

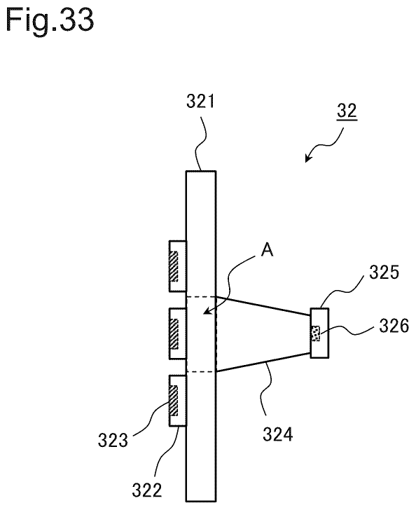

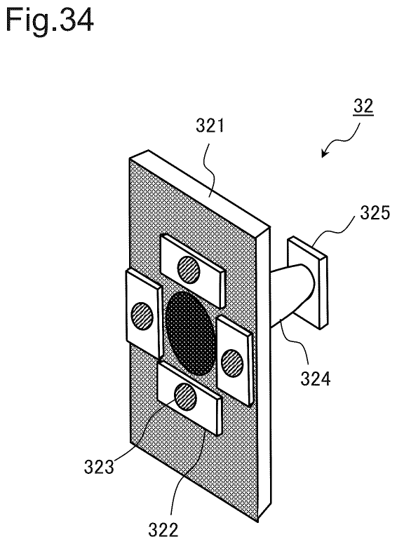

FIG. 32 is a conceptual diagram illustrating an example of a configuration of a reception device 30 according to the present disclosure. FIG. 32 is a conceptual diagram of the reception device 30 viewed from obliquely above. FIGS. 33 to 34 are side views illustrating an example of a configuration of a light receiver 32 included in the reception device 30. FIG. 33 is a side view of the light receiver 32 when viewed from a side. FIG. 34 is a perspective view of the light receiving face of the light receiver 32 when viewed obliquely from above.

The reception device 30 includes a ball lens 31, at least one light receiver 32, and a support column 38. The light receiver 32 includes a substrate 321, a plurality of integration light receiving elements 322, a light guide tube 324, and a communication light receiving element 325. The substrate 321 has a first face facing the ball lens 31 and a second face facing the first face. The substrate 321 has a through hole A penetrating the first face and the second face. The plurality of integration light receiving elements 322 is disposed around the through hole A on the first face of the substrate 321 with a light reception part 323 facing the ball lens 31. The light guide tube 324 includes a first opening end associated with the through hole A and a second opening end facing the first opening end. The light guide tube 324 is disposed, on the side of the second face of the substrate 321, to coincide with the position of the through hole A. The communication light receiving element 325 is disposed at the second opening end of the light guide tube 324 with a light reception part 326 facing the ball lens 31. The light receiver is movably supported around the support column 38 and the ball lens 31. In the example of FIG. 32, the light receiver 32 is disposed at the upper end of the support column 38. The lower end of the support column 38 is disposed in such a way as to be movable along the annular circular orbit R.

According to the reception device of the present example embodiment, the light receiving face of the light receiver can be oriented in an azimuth of 360 degrees by moving the light receiver around the ball lens. That is, according to the present example embodiment, a communication angle of 360 degrees can be achieved.

### (Hardware)

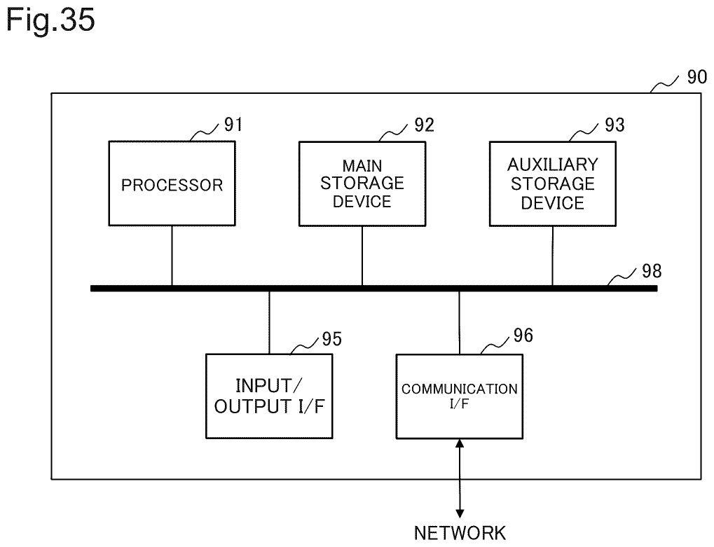

Next, a hardware configuration for executing control and processing in the present disclosure will be described with reference to the drawings. An example of such a hardware configuration is an information processing device 90 (computer) in FIG. 35. The information processing device 90 in FIG. 35 is a configuration example for executing control and processing in the present disclosure, and does not limit the scope of the present disclosure.

As illustrated in FIG. 35, the information processing device 90 includes a processor 91, a main storage device 92, an auxiliary storage device 93, an input/output interface 95, and a communication interface 96. In FIG. 35, the interface is abbreviated as an interface (I/F). The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing control and processing in the present disclosure. The processor 91 executes the program developed in the main storage device 92. The processor 91 executes control and processing in the present disclosure by executing a program.

The main storage device 92 has an area in which a program is developed. A program stored in the auxiliary storage device 93 or the like is developed in the main storage device 92 by the processor 91. The main storage device 92 is achieved by, for example, a volatile memory such as a dynamic random access memory (DRAM). As the main storage device 92, a nonvolatile memory such as a magneto resistive random access memory (MRAM) may be configured/added.

The auxiliary storage device 93 stores various pieces of data such as programs. The auxiliary storage device 93 is achieved by a local disk such as a hard disk or a flash memory. Various pieces of data may be stored in the main storage device 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling the control and processing according to the present disclosure. The hardware configuration of FIG. is an example of a hardware configuration for executing control and processing in the present disclosure, and does not limit the scope of the present disclosure. A program for causing a computer to execute control and processing in the present disclosure is also included in the scope of the present disclosure.

A program recording medium recording a program in the present disclosure is also included in the scope of the present disclosure. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium. In a case where the program executed by the processor is recorded in the recording medium, the recording medium corresponds to a program recording medium.

The components in the present disclosure may be combined in any manner. The components in the present disclosure may be implemented by software. The components in the present disclosure may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A reception device comprising:
a ball lens;
at least one light receiver; and
a support column that movably supports the light receiver around the ball lens, wherein
the light receiver includes
a substrate having a first face facing the ball lens and a second face facing the first face, the substrate having a through hole penetrating the first face and the second face,
a plurality of integration light receiving elements disposed around the through hole on the first face of the substrate with a light reception part facing the ball lens,
a light guide tube including a first opening end associated with the through hole and a second opening end facing the first opening end, the light guide tube being disposed, on a side of the second face of the substrate, to coincide with a position of the through hole, and
a communication light receiving element disposed at the second opening end of the light guide tube with a light reception part facing the ball lens.

2. The reception device according to claim 1, wherein
the plurality of integration light receiving elements is disposed in a point-symmetric positional relationship with respect to a center of the through hole, and
the light reception part of the communication light receiving element is disposed to be aligned with a condensing point of the ball lens.

3. The reception device according to claim 2, further comprising
a controller that comprises a memory storing instructions, and a processor connected to the memory and configured to execute the instructions to
receive an electric signal based on signal light received by the plurality of integration light receiving elements and the communication light receiving element, and
adjust an angle of a light receiving face of the light receiver and a position of the support column according to the received electric signal, wherein
the processor is configured to execute the instructions to
adjust the angle of the light receiving face of the light receiver and the position of the support column according to intensity of signal light received by each of the plurality of integration light receiving elements, and
adjust a position of the light reception part of the communication light receiving element in accordance with a condensing position of signal light condensed by the ball lens.

4. The reception device according to claim 3, wherein
the processor is configured to execute the instructions to
move the angle of the light receiving face of the light receiver and the position of the support column toward a direction of the integration light receiving element whose reception intensity is larger according to the intensity of signal light received by each of the plurality of integration light receiving elements.

5. The reception device according to claim 1, further comprising
a filter that selectively transmits light in a wavelength band of a spatial optical signal to be received is disposed in association with light reception parts of the plurality of the integration light receiving elements and the communication light receiving element.

6. The reception device according to claim 1, wherein
the integration light receiving elements and the communication light receiving element are a light receiving elements having sensitivity to light of different wavelength bands.

7. A communication device comprising:
the reception device according to claim 1;
a transmission device that transmits a spatial optical signal; and
a communication control device that comprises a memory storing instructions, and a processor connected to the memory and configured to execute the instructions to control, according to a light receiving position of a spatial optical signal received by a light receiver of the reception device, a position and an angle of the light receiver and a transmission direction of the spatial optical signal transmitted from the transmission device.

8. The communication device according to claim 7, wherein
the processor of the communication control device is configured to execute the instructions to
cause the transmission device to transmit a search spatial optical signal of a transmission pattern in which a modulation frequency and a signal pattern that vary depending on a transmission direction of a spatial optical signal are combined, in association with the transmission direction, and
cause the transmission device to transmit a spatial optical signal to which a transmission pattern of the received search spatial optical signal is added in association with the transmission direction in response to reception by the reception device of a search spatial optical signal transmitted from a communication target.

9. The communication device according to claim 8, wherein
in response to reception by the reception device of a search spatial optical signal transmitted from the communication target,
the processor of the communication control device is configured to execute the instructions to
cause the reception device to change a position of the light receiver according to intensity of signal light based on a search spatial optical signal received by each of a plurality of integration light receiving elements included in the reception device, and
transmit an instruction to change a transmission condition of the search spatial optical signal to the transmission device.

10. The communication device according to claim 9, wherein
the processor of the communication control device is configured to execute the instructions to
cause the transmission device to transmit a search spatial optical signal in which a search range and a beam diameter are narrowed in response to identification of mutual direction between the communication target and the communication device, and
execute detailed scanning using the communication light receiving element in response to completion of position adjustment of the light receiver using the integration light receiving elements.
